(19) United States
(12) Patent Application Publication
(10) Pub. No.: US 2025/0048438 A1
(43) Pub. Date: Feb. 6, 2025

(54) METHOD, USER EQUIPMENT, AND COMMUNICATION SYSTEM FOR MTRP-BASED OPERATIONS

(71) Applicant: FG Innovation Company Limited, Tuen Mun (HK)

(72) Inventors: CHIA-HUNG LIN, Taipei (TW); Mei-Ju Shih, Taipei (TW); Yen-Hua Li, Taipei (TW); Chie-Ming Chou, Taipei (TW)

(21) Appl. No.: 18/793,496

(22) Filed: Aug. 2, 2024

Related U.S. Application Data
(60) Provisional application No. 63/530,797, filed on Aug. 4, 2023.

(51) Int. Cl. H04W 74/0833; H04W 56/00; H04W 74/00

(52) U.S. Cl. CPC H04W 74/0833; H04W 56/0045; H04W 74/006

(57) ABSTRACT

A method performed by a UE for an mTRP-based operation is provided. The method receives, from a serving cell, a serving cell configuration including a first TAG ID associated with a first PCI of the serving cell and a second TAG ID associated with a second PCI of a non-serving cell. The method receives, from the serving cell, DCI for initiating an RA procedure, the DCI including a field indicating that a PRACH is associated with the first TAG ID or the second TAG ID. The method then transmits, based on the field, the PRACH to the serving cell or the non-serving cell.

### CROSS-REFERENCE TO RELATED APPLICATION(S)

The present disclosure claims the benefit of and priority to U.S. Provisional Patent Application Ser. No. 63/530,797, filed on Aug. 4, 2023, entitled “Methods for Supporting TA Maintenance for Multi-DCI based UL Transmission with 2 TAs,” the content of which is hereby incorporated herein fully by reference into the present disclosure for all purposes.

### FIELD

The present disclosure is related to wireless communication and, more specifically, to a method, a user equipment (UE), and a communication system for a multi-transmission and reception point (mTRP)-based operation in wireless communication networks.

### BACKGROUND

Various efforts have been made to improve different aspects of wireless communication for the cellular wireless communication systems, such as the 5^{th} Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to grow, however, there is a need for further improvements in wireless communications in the next-generation wireless communication systems.

### SUMMARY

The present disclosure is related to a method, a user equipment (UE), and a communication system for a multi-transmission and reception point (mTRP)-based operation in wireless communication networks.

In a first aspect of the present application, a method performed by a UE for a multi-transmission and reception point (mTRP)-based operation is provided. The method includes receiving, from a serving cell, a serving cell configuration including a first timing advance group (TAG) identity (ID) associated with a first physical cell identity (PCI) of the serving cell and a second TAG ID associated with a second PCI of a non-serving cell; receiving, from the serving cell, downlink control information (DCI) for initiating a random access (RA) procedure, the DCI including a field indicating that a physical random access channel (PRACH) is associated with the first TAG ID or the second TAG ID; and transmitting, based on the field, the PRACH to the serving cell or the non-serving cell.

In an implementation of the first aspect, the method further includes in a case that the field indicates that the PRACH is associated with the second TAG ID, transmitting the PRACH based on an RA resource associated with the second TAG ID.

In another implementation of the first aspect, the method further includes in a case that the field indicates that the PRACH is associated with the first TAG ID: transmitting, based on the field, the PRACH to the serving cell, and receiving, from the serving cell, a random access response (RAR); and in a case that the field indicates that the PRACH is associated with the second TAG ID: transmitting, based on the field, the PRACH to the non-serving cell, and receiving, from the serving cell, the RAR.

In another implementation of the first aspect, in a case that the field indicates that the PRACH is associated with the first TAG ID, the RAR indicates a first timing advance (TA) value associated with the first TAG ID, and in a case that the field indicates that the PRACH is associated with the second TAG ID, the RAR indicates a second TA value associated with the second TAG ID.

In another implementation of the first aspect, the method further includes in a case that a timing alignment timer (TAT) associated with the first TAG ID expires, clearing every configured downlink assignment associated with the first TAG ID, without clearing any configured uplink grant associated with the first TAG ID.

In another implementation of the first aspect, the method further includes in a case that a timing alignment timer (TAT) associated with the first TAG ID expires, clearing every configured uplink grant associated with the first TAG ID, without clearing any configured downlink assignment associated with the first TAG ID.

In another implementation of the first aspect, the method further includes in a case that a timing alignment timer (TAT) associated with the first TAG ID expires, clearing every physical uplink shared channel (PUSCH) resource for a semi-persistent channel state information (CSI) reporting associated with the first TAG ID, without maintaining a timing advance (TA) related parameter associated with the first TAG ID.

In another implementation of the first aspect, the method further includes in a case that a timing alignment timer (TAT) associated with the first TAG ID expires, maintaining a timing advance (TA) related parameter associated with the first TAG ID, without clearing any physical uplink shared channel (PUSCH) resource for a semi-persistent channel state information (CSI) reporting associated with the first TAG ID.

In a second aspect of the present application, a UE for a multi-transmission and reception point (mTRP)-based operation is provided. The UE includes at least one processor; and at least one non-transitory computer-readable medium coupled to at least one processor, and storing one or more computer-executable instructions that, when executed by the at least one processor, cause the UE to receive, from a serving cell, a serving cell configuration including a first timing advance group (TAG) identity (ID) associated with a first physical cell identity (PCI) of the serving cell and a second TAG ID associated with a second PCI of a non-serving cell; receive, from the serving cell, downlink control information (DCI) for initiating a random access (RA) procedure, the DCI including a field indicating that a physical random access channel (PRACH) is associated with the first TAG ID or the second TAG ID; and transmit, based on the field, the PRACH to the serving cell or the non-serving cell.

In a third aspect of the present application, a method performed by a communication system for a multi-transmission and reception point (mTRP)-based operation is provided. The communication system includes a user equipment (UE), a serving cell, and a non-serving cell. The method includes receiving, by the UE, a serving cell configuration from the serving cell, the serving cell configuration including a first timing advance group (TAG) identity (ID) associated with a first physical cell identity (PCI) of the serving cell and a second TAG ID associated with a second PCI of a non-serving cell; receiving, by the UE, downlink control information (DCI) for initiating a random access (RA) procedure from the serving cell, the DCI including a field indicating that a physical random access channel (PRACH) is associated with the first TAG ID or the second TAG ID; and transmitting, by the UE, the PRACH to the serving cell or the non-serving cell based on the field.

In an implementation of the third aspect, in a case that the field indicates that the PRACH is associated with the second TAG ID, transmitting, by the UE, the PRACH based on an RA resource associated with the second TAG ID.

In another implementation of the third aspect, in a case that the field indicates that the PRACH is associated with the first TAG ID: transmitting, by the UE, the PRACH to the serving cell based on the field, and receiving, by the UE, a random access response (RAR) from the serving cell; and in a case that the field indicates that the PRACH is associated with the second TAG ID: transmitting, by the UE, the PRACH to the non-serving cell based on the field, and receiving, by the UE, the RAR from the serving cell.

In another implementation of the third aspect, in a case that the field indicates that the PRACH is associated with the first TAG ID, the RAR indicates a first timing advance (TA) value associated with the first TAG ID, and in a case that the field indicates that the PRACH is associated with the second TAG ID, the RAR indicates a second TA value associated with the second TAG ID.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a schematic diagram illustrating an mTRP-based UL transmission performed by a UE, according to an example implementation of the present disclosure.

FIG. 2 is a flowchart illustrating a method/process performed by a UE for an mTRP-based operation, according to an example implementation of the present disclosure.

FIG. 3 is a flowchart illustrating a method/process performed by a communication system for an mTRP-based operation, according to an example implementation of the present disclosure.

FIG. 4 is a block diagram illustrating a node for wireless communication, according to an example implementation of the present disclosure.

### DESCRIPTION

Some of the abbreviations used in this disclosure include:

| Abbreviation | Full name |
|---|---|
| 3GPP | 3^{rd} Generation Partnership Project |
| 5G | 5^{th} Generation |
| ACK | Acknowledgment |
| BWP | Bandwidth Part |
| CA | Carrier Aggregation |
| CB | CodeBook |
| CBRA | Contention-Based Random Access |
| CC | Component Carrier |
| CCE | Control Chanel Element |
| CE | Control Element |
| CFRA | Contention-Free Random Access |
| CG | Configured Grant |
| CHO | Conditional Handover |
| CORESET | Control resource set |
| CPE | Customer Premises Equipment |
| CRC | Cyclic Redundancy Check |
| C-RNTI | Cell-Radio Network Temporary Identifier |
| CS-RNTI | Configured Scheduling-Radio Network Temporary |
| | Identifier |
| CSS | Common Search Space |
| CSI | Channel State Information |
| DAPS | Dual Active Protocol Stack |
| DC | Dual Connectivity |
| DCI | Downlink Control Information |
| DL | Downlink |
| FWA | Fixed Wireless Access |
| GC-PDCCH | Group Common-Physical Downlink Control Channel |
| HARQ | Hybrid Automatic Repeat Request |
| HO | Handover |
| IE | Information Element |
| IIoT | Industrial Internet of Things |
| LSB | Least Significant Bit |
| LTE | Long Term Evolution |
| LTM | Layer 1/Layer 2-Triggered Mobility |
| L1 | Layer 1 |
| L2 | Layer 2 |
| L3 | Layer 3 |
| MAC | Medium Access Control |
| MCG | Master Cell Group |
| MCS | Modulation Coding Scheme |
| MCS-C- | Modulation Coding Scheme-Cell-Radio Network |
| RNTI | Temporary Identifier |
| MIMO | Multiple-input Multiple-output |
| MSB | Most Significant Bit |
| mTRP | Multiple Transmission and Reception Point |
| NACK | Negative Acknowledgment |
| NDI | New Data Indicator |
| Non-CB | Non-CodeBook |
| NR | New RAT/Radio |
| NW | Network |
| PBCH | Physical Broadcast Channel |
| PCell | Primary Cell |
| PCI | Physical Cell ID |
| PDCCH | Physical Downlink Control Channel |
| PDSCH | Physical Downlink Shared Channel |
| PDU | Protocol Data Unit |
| PH | Power Headroom |
| PHR | Power Headroom Report |
| PHY | Physical (layer) |
| P-MPR | Power management Maximum Power Reduction |
| PRACH | Physical Random Access Channel |
| PSCell | Primary Secondary Cell |
| PTAG | Primary Timing Advance Group |
| PTRS | Phase Tracking Reference Signal |
| PUCCH | Physical Uplink Control Channel |
| PUSCH | Physical Uplink Shared Channel |
| RA | Random Access |
| RACH | Random Access Channel |
| RAN | Radio Access Network |
| RAR | Random Access Response |
| Rel | Release |
| RLF | Radio Link Failure |
| RMSI | Remaining Minimum System Information |
| RNTI | Radio Network Temporary Identifier |
| RRC | Radio Resource Control |
| RSRP | Reference Signal Received Power |
| RSRQ | Reference Signal Received Quality |
| RSSI | Reference Signal Strength Indication |
| RV | Redundancy Version |
| SCell | Secondary Cell |
| SCG | Secondary Cell Group |
| SCS | Subcarrier Spacing |
| SDM | Spatial Division Multiplexing |
| SFN | Single Frequency Network |
| SINR | Signal to Interference plus Noise Ratio |
| SN | Secondary Node |
| SpCell | Special Cell |
| SPS | Semi-Persistent Scheduling |
| SR | Scheduling Request |
| SRS | Sounding Reference Signal |
| SRI | SRS resource indicator |
| SSB | Synchronization Signal Block |
| STAG | Secondary Timing Advance Group |
| STxMP | Simultaneous Transmission on Multiple Panels |
| TA | Timing Advance |
| TAC | Timing Advance Command |
| TAG | Timing Advance Group |
| TB | Transport Block |
| TBS | Transport Block |
| TCI | Transmission Configuration Indication |
| TDM | Time Division Multiplexing |
| TPC | Transmission Power Control |
| TPMI | Transmission Precoding Matrix Indicator |
| TR | Technical Report |
| TRI | Transmit Rank Indication |
| TRP | Transmission and Reception Point |
| TS | Technical Specification |
| QCL | Quasi-CoLocation |
| UE | User Equipment |
| UL | Uplink |
| URLLC | Ultra Reliable Low Latency Communication |
| USS | UE-Specific Search Space |
| WCDMA | Wideband Code Division Multiple Access |
| WG | Working Group |
| WI | Working Item |
| ZP-CSI-RS | Zero power CSI-RS |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly included to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture, such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network, such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using multiple cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via multiple cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may include the SpCell of an MCG. A Primary SCG Cell (PSCell) may include the SpCell of an SCG. MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells.

As previously disclosed, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least the DL transmission data, a guard period, and the UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behavior, term, or claim described in the present disclosure may be implemented independently and separately to form a specific method.

Dependency, e.g., “based on”, “more specifically”, “preferably”, “in one embodiment”, “in some implementations”, etc., in the present disclosure is just one possible example and shall not restrict the specific method.

“A and/or B” in the present disclosure may include either A or B, both A and B, at least one of A and B.

In the present disclosure, although a gNB is used as an example for a BS, other types of the BS (e.g., an eNB) may be equally applicable in the present disclosure.

Descriptions of some selected terms in the present disclosure are provided as follows.

Antenna Panel: A conceptual term for the UE antenna implementation. It may be assumed that a panel is an operational unit for controlling a transmission spatial filter (e.g., a beam). A panel may typically include multiple antenna elements. In some implementations, a beam may be formed by a panel. To form two beams simultaneously, two panels may be needed. Such simultaneous beamforming from multiple panels may be subject to a UE's capability (which may also be referred to as the UE capability in this disclosure). A similar definition for “panel” may be applicable by applying spatial receiving filtering characteristics.

Beam: The term “beam” may be interpreted as a spatial filter. For example, when a UE reports a preferred gNB transmission (TX) beam, the UE may be essentially selecting a spatial filter used by the gNB. The term “beam information” may include information about which beam/spatial filter is being used/selected. In some implementations, individual reference signals may be transmitted by applying individual beams (e.g., spatial filters). Thus, the term “beam” or “beam information” may be represented by reference signal resource index(es).

DCI: There may be various DCI formats used in the PDCCH in the LTE. The DCI format may be a predefined format in which the downlink control information is packed/formed and transmitted in the PDCCH.

TCI state: A TCI state may include parameters for configuring a QCL relationship between one or two DL reference signals and a target reference signal set. For example, a target reference signal set may include the Demodulation Reference Signals (DM-RS) ports of a PDSCH or a PDCCH.

TA: The TA may be a value carried by a MAC CE to control the UL signal transmission timing.

HARQ: The HARQ may be a functionality that ensures the delivery between peer entities at Layer 1 (e.g., physical layer). A single HARQ process may support one TB when the physical layer is not configured for the downlink/uplink spatial multiplexing. When the physical layer is configured for the downlink/uplink spatial multiplexing, a single HARQ process may support one or more TBs. There may be one HARQ entity per serving cell. Each HARQ entity may support a parallel number of DLs and UL HARQ processes.

The mTRP-based UL transmission has been developed to improve the system throughput. Based on such a mechanism (e.g., the mTRP-based UL transmission), a UE may transmit multiple UL channels/signals (e.g., the PUCCHs or the PUSCHs) to different TRPs. Since different TRPs may be located in different geographical locations, different transmit parameters (e.g., the SRI, the TPMI, and/or the TPC) may be configured or indicated to the UE by the NW/gNB via the RRC signaling, the MAC CE, and/or the DCI. In addition to these transmit parameters, a TRP-specific TA may be required to be acquired and maintained for the mTRP-based UL transmission to prevent the system performance (e.g., throughput and/or reliability) loss.

Specifically, to avoid the system performance loss during the mTRP-based UL transmission, the UE may need to acquire and/or maintain the TA corresponding to each TRP configured for the mTRP-based UL transmission, instead of acquiring and/or maintaining one TA for multiple TRPs configured for the mTRP-based UL transmission. It should be noted that the TRP, as described in the present disclosure, may be associated with an SRS resource set, a CORESETPoolIndex, a TCI state, a TAG ID, and/or an additionalPCIIndex.

In some implementations, a UE may be configured with two SRS resource sets corresponding to the CB-based and/or the NCB-based PUSCH transmissions for performing the mTRP-based PUSCH transmission by the NW, for example, via the RRC signaling. Each SRS resource set may be associated with a TRP. In some implementations, a UE may be configured with two CORESETPoolIndex values (e.g., CORESETPoolIndex=0 and CORESETPoolIndex=1) by the NW via the RRC signaling. Each CORESETPoolIndex value (e.g., CORESETPoolIndex=0 or CORESETPoolIndex=1) may be associated with a TRP. It should be noted that CORESETPoolIndex=0 may mean that the RRC parameter coresetPoolIndex is set to “0” and CORESETPoolIndex=1 may mean that the RRC parameter coresetPoolIndex is set to “1.”

For an mTRP-based UL transmission, two types of mTRP-based UL transmissions may be categorized, as the single-DCI-based mTRP-based UL transmission and the multi-DCI-based mTRP-based UL transmissions. It should be noted that the UE may be configured, by the gNB/NW, with two SRS resource set configurations for the mTRP-based UL transmission. Each SRS resource set configuration may be associated with a TRP.

For a single-DCI-based mTRP-based UL transmission, the UE may receive the DCI (e.g., the DCI format 0_0, DCI format 0_1, and/or DCI format 0_2) scheduling the UL transmissions between the UE and multiple TRPs, and the DCI may be transmitted by the gNB/NW. To schedule the UL transmissions between the UE and two TRPs, the DCI may include one or multiple SRI fields, TPMI fields, and/or TPC fields used to indicate the transmit parameters to the UE for performing the mTRP-based UL transmission. It should be noted that the TPMI field may be used to indicate the precoding information and the number of layers. For a multi-DCI-based mTRP-based UL transmission, the UE may receive multiple DCIs (e.g., the DCI format 0_0, DCI format 0_1, and/or DCI format 0_2) scheduling the UL transmissions between the UE and multiple TRPs, and each DCI may be transmitted by different TRPs individually. In addition, each DCI may be associated with a CORESETPoolIndex value. For example, a UE may be configured with multi-DCI-based mTRP-based UL transmissions with two TRPs by the gNB/NW. And the DCI transmitted by each TRP may be associated with a CORESETPoolIndex value (e.g., the DCI transmitted by the first TRP may be associated with the CORESETPoolIndex value set to 0 and the DCI transmitted by the second TRP may be associated with the CORESETPoolIndex value set to 1).

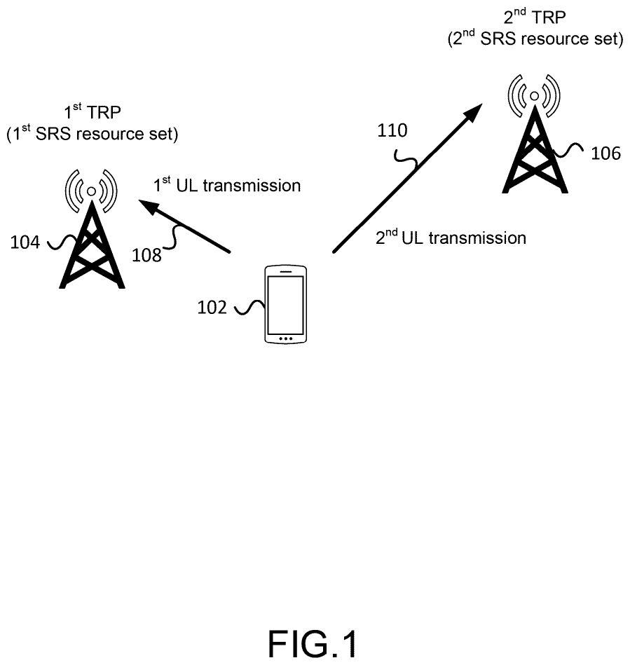

FIG. 1 is a schematic diagram illustrating an mTRP-based UL transmission performed by a UE 102, according to an example implementation of the present disclosure. As illustrated in FIG. 1, the UE 102 may be configured, by the gNB/NW, to perform the mTRP-based UL transmission. The UE 102 may perform the first UL transmission 108 to the first TRP 104 based on the first SRS resource set and perform the second UL transmission 110 to the second TRP 106 based on the second SRS resource set. In other words, the first SRS resource set may be associated with the first TRP 104 and the second SRS resource set may be associated with the second TRP 106.

In some implementations, if the UE is configured by the gNB/NW to perform a single-DCI-based mTRP-based UL transmission, the UE may receive the DCI from the first TRP or the second TRP. The DCI may include DCI format 0_0, DCI format 0_1, and/or DCI format 0_2. In some implementations, the DCI may include a first SRI field, a second SRI field, a first TPMI field, a second TPMI field, and/or an SRS resource set field. The SRS resource set field may be used to perform the dynamic switching between the single TRP-based UL transmission and the mTRP-based UL transmission. The SRS resource set field may be used to indicate the transmission order for the first UL transmission and the second UL transmission.

The value indicated by the SRS resource set field may be set to different values to indicate different types of TRP-based UL transmissions and mTRP-based UL transmissions to different destinations. In the following paragraphs, the numbers to which the SRS resource set field is set are only examples and other numbers/values may be used for the SRS resource set field to indicate the different types of TRP-based UL transmissions and mTRP-based UL transmissions to different destinations.

If the value indicated by the SRS resource set field is set to “0,” the UE may be configured to perform the single TRP-based UL transmission to the first TRP based on the first SRS resource set. The first SRI field and the first TPMI field may be used to indicate a first SRI value and a first TPMI value for the first UL transmission, respectively. The first SRI field and the first TPMI field may be associated with the first SRS resource set. The second SRI field and the second TPMI field may be reserved.

If the value indicated by the SRS resource set field is set to “1,” the UE may be configured to perform the single TRP-based UL transmission to the second TRP based on the second SRS resource set. The first SRI field and the first TPMI field may be used to indicate a first SRI value and a first TPMI value for the second UL transmission, respectively. The first SRI field and the first TPMI field may be associated with the second SRS resource set. The second SRI field and the second TPMI field may be reserved.

If the value indicated by the SRS resource set field is set to “2,” the UE may be configured to perform the mTRP-based UL transmission to the first TRP based on the first SRS resource set and the second TRP based on the second SRS resource set. The first SRI field and the first TPMI field may be used to indicate a first SRI value and a first TPMI value for the first UL transmission, respectively. The first SRI field and the first TPMI field may be associated with the first SRS resource set. The second SRI field and the second TPMI field may be used to indicate a second SRI value and a second TPMI value for the second UL transmission, respectively. The second SRI field and the second TPMI field may be associated with the second SRS resource set. The transmission order may include the UE performing the first UL transmission first, and then the UE performing the second UL transmission. In other words, the UE may apply the first SRS resource set for the first UL transmission first, and then apply the second SRS resource set for the second UL transmission.

If the value indicated by the SRS resource set field is set to “3,” the UE may be configured to perform the mTRP-based UL transmission to the first TRP based on the first SRS resource set and the second TRP based on the second SRS resource set. The first SRI field and the first TPMI field may be used to indicate a first SRI value and a first TPMI value for the first UL transmission, respectively. The first SRI field and the first TPMI field may be associated with the first SRS resource set. The second SRI field and the second TPMI field may be used to indicate a second SRI value and a second TPMI value for the second UL transmission, respectively. The second SRI field and the second TPMI field may be associated with the second SRS resource set. The transmission order may include the UE performing the second UL transmission first, and then the UE performing the first UL transmission. In other words, the UE may apply the second SRS resource set for the second UL transmission first, and then apply the first SRS resource set for the first UL transmission.

In some implementations, if the UE is configured by the gNB/NW to perform the multi-DCI-based mTRP-based UL transmissions, the UE may receive first DCI from the first TRP and second DCI from the second TRP. The first DCI and the second DCI may include DCI format 0_0, DCI format 0_1, and/or DCI format 0_2. The first DCI may be associated with the first CORESETPoolIndex and the second DCI may be associated with the second CORESETPoolIndex. The value of the first CORESETPoolIndex may be different from the second CORESETPoolIndex. For example, the first RRC-configured coresetPoolIndex value (e.g., corresponding to the value of the first CORESETPoolIndex) may be set to 0 and the second RRC-configured coresetPoolIndex value (e.g., corresponding to the value of the second CORESETPoolIndex) may be set to 1. As another example, the first RRC-configured coresetPoolIndex value (e.g., corresponding to the value of the first CORESETPoolIndex) may be set to 1 and the second RRC-configured coresetPoolIndex value (e.g., corresponding to the value of the second CORESETPoolIndex) may be set to 0.

In some implementations, as illustrated in FIG. 1, if the UE 102 is configured by the gNB/NW to perform the multi-DCI-based mTRP-based UL transmission, the UE 102 may receive the first DCI scheduling the first UL transmission 108 and the second DCI scheduling the second UL transmission 110. The first DCI may be associated with the first CORESETPoolIndex and the second DCI may be associated with the second CORESETPoolIndex.

In order to perform the mTRP-based UL transmission (e.g., the single-DCI-based mTRP-based UL transmission and/or the multi-DCI-based mTRP-based UL transmission) without a system performance loss, the UE may need to acquire and maintain multiple TAs for each UL transmission to different TRPs. In other words, the TRP-specific TAs may be acquired and/or maintained by the UE.

In some implementations, if a UE is configured to perform the mTRP-based UL transmission, the UE may receive the DCI (e.g., the DCI format 1_0) triggering the RA procedure corresponding to any TRP. It should be noted that each TRP may be associated with a TRP ID, a CORESETPoolIndex value, an SRS resource set, a PCI value, and/or an additionalPCIIndex.

In some implementations, a UE may be configured with a PRACH configuration by the gNB/NW via RRC signaling. The PRACH configuration may be applied for each RA procedure triggered by the PDCCH order for the multi-TRP-based UL transmission. It should be noted that each RA procedure may be used to acquire the TA for different TRPs associated with different CORESETPoolIndex values (e.g., the RRC-configured parameter coresetPoolIndex is set to “0” or “1”), PCI values, and/or additionalPCIIndex values. Each acquired TA may be associated with a TAG ID.

In some implementations, a UE may receive, from a serving cell/gNB/NW, an RRC message including the PRACH configuration corresponding to the serving cell. The UE may receive, from the serving cell/gNB/NW, the DCI (e.g., the DCI format 1_0) used to trigger the RA procedure corresponding to one of the two TRPs configured to the UE, by the serving cell/gNB/NW, for performing the mTRP-based UL transmission. It should be noted that the two TRPs may be associated with the serving cell. In some implementations, one TRP may be associated with the serving cell while the other TRP may be associated with another cell (e.g., the SCell, the PSCell, the target cell, or the neighboring cell). The UE may then transmit a preamble, based on the instructions provided by the DCI and the RRC-configured PRACH configuration, to the one of the two TRPs. After the UE transmits the preamble to the one of the two TRPs, the UE may receive a RAR from the serving cell. In some implementations, the received RAR may include a field indicating the TAG ID. The TA value indicated in the received RAR may be associated with the TAG ID indicated in the received RAR.

The UE may be configured by the serving cell/gNB/NW, via RRC signaling, with two TAG IDs associated with a serving cell. The TAG ID indicated in the received RAR may be associated with one of the two TAG IDs associated with the serving cell.

In some implementations, a UE may receive, from a serving cell/gNB/NW, an RRC message including the PRACH configuration corresponding to the serving cell and/or the association between the SSBs and the TAG IDs associated with the serving cell. The UE may receive, from the serving cell/gNB/NW, the DCI (e.g., the DCI format 1_0) used to trigger the RA procedure corresponding to one of the two TRPs configured to the UE, by the serving cell/gNB/NW, for performing the mTRP-based UL transmission. The UE may then transmit a preamble, based on the instructions provided by the DCI and the RRC-configured PRACH configuration, to the one of the two TRPs. After the UE transmits the preamble to the one of the two TRPs, the UE may receive a RAR from the serving cell. The TA value indicated in the RAR may be associated with one of the two TAG IDs associated with the serving cell. Which TAG ID is associated with the TA value indicated in the RAR may be determined based on the SS/PBCH index field included in the DCI.

In some implementations, the association between the SSBs and the TAG IDs associated with a serving cell may be predefined or provided by the serving cell/gNB/NW via RRC signaling. In some implementations, the SSBs indicated in the RRC signaling may be divided into two groups, where one group of SSBs may be associated with the first TAG ID and the other group of SSBs may be associated with the second TAG ID. For example, if there are 64 SSBs, the first thirty-two SSBs (e.g., from SSB #0 to SSB #31) may be associated with the first TAG ID of the two TAG IDs associated with a serving cell, and the other SSBs (e.g., from SSB #32 to SSB #63) may be associated with the second TAG ID of the two TAG IDs associated with the serving cell.

As another example, if there are 64 SSBs, the first thirty-two SSBs (e.g., from SSB #0 to SSB #31) may be associated with the second TAG ID of the two TAG IDs associated with a serving cell, and the other SSBs (e.g., from SSB #32 to SSB #63) may be associated with the first TAG ID of the two TAG IDs associated with the serving cell. In some implementations, the SSBs indicated in the RRC signaling may be divided into more than two groups, where one group of SSBs may be associated with the first TAG ID, another group of SSBs may be associated with the second TAG ID, and another group of SSBs may be common for both the first TAG ID and the second TAG ID. In some implementations, the SSBs indicated in the RRC signaling may be divided into more than two groups, where one group of SSBs may be associated with the first TAG ID, another group of SSBs may be associated with the second TAG ID, and another group of SSBs may be reserved for other usage(s).

The first TAG ID of the two TAG IDs associated with a serving cell may be the TAG ID with the lowest ID among the two TAG IDs associated with the serving cell. The second TAG ID of the two TAG IDs associated with the serving cell may be any other TAG ID except the first TAG ID of the two TAG IDs associated with the serving cell.

A serving cell may be associated with a PTAG and an STAG. The first TAG ID of the two TAG IDs associated with the serving cell may be the TAG ID associated with the PTAG. The second TAG ID of the two TAG IDs associated with the serving cell may be the TAG ID associated with the STAG.

The first TAG ID of the two TAG IDs associated with a serving cell may be the TAG ID associated with the RRC-configured coresetPoolIndex set to “0.” The second TAG ID of the two TAG IDs associated with the serving cell may be the TAG ID associated with the RRC-configured coresetPoolIndex set to “1.”

In some implementations, a serving cell may be associated with the PTAG, and the PTAG may include a sub PTAG and a sub STAG. The first TAG ID of the two TAG IDs associated with the serving cell may be the TAG ID associated with the sub PTAG. The second TAG ID of the two TAG IDs associated with the serving cell may be the TAG ID associated with the sub STAG. In some implementations, the received RAR may include a field indicating the TAG ID. The TA value indicated in the received RAR may be associated with the TAG ID indicated in the received RAR. The UE may be configured by the serving cell/gNB/NW, via RRC signaling, with two TAG IDs associated with a serving cell. The TAG ID indicated in the received RAR may be associated with one of the two TAG IDs associated with the serving cell.

In some implementations, a UE may be configured with multiple PRACH configurations by the gNB/NW via RRC signaling. Each RRC-configured PRACH configuration may be associated with a TRP. Specifically, the TRP-specific PRACH configuration may be configured to the UE by the gNB/NW via RRC signaling. In some implementations, each RRC-configured PRACH configuration may be associated with a CORESETPoolIndex, a PCI value, and/or an additionalPCIIndex. Each RRC-configured PRACH configuration may be applied for its corresponding RA procedure triggered by the PDCCH order. For example, each RRC-configured PRACH configuration may include the CORESETPoolIndex, the PCI value, and/or the additionalPCIIndex with which the RRC-configured PRACH configuration is associated. Each RA procedure may be used to acquire the TA for the corresponding TRPs. Different TRPs may be associated with different CORESETPoolIndex values (e.g., the RRC-configured parameter coresetPoolIndex is set to “0” or “1”), PCI values, and/or additionalPCIIndex values. Each acquired TA may be associated with a TAG ID.

In some implementations, a UE may receive, from a serving cell/gNB/NW, an RRC message including the PRACH configuration corresponding to the serving cell and the PRACH configuration corresponding the cell having a PCI different from the PCI of the serving cell. The UE may receive, from the serving cell, the cell associated with the PCI different from the PCI of the serving cell, gNB, or NW, DCI (e.g., the DCI format 1_0) used to trigger the RA procedure corresponding to one of the two TRPs configured to the UE by the serving cell/gNB/NW for performing the mTRP-based UL transmission. The UE may then transmit a preamble, based on the instructions provided by the DCI and the one of the RRC-configured PRACH configurations, to the one of the two TRPs. After the UE transmits the preamble to the one of the two TRPs, the UE may receive a RAR from the serving cell.

In some implementations, the DCI triggering the RA procedure may include a field to identify to which TRP the triggered RA procedure corresponds (e.g., the serving cell, the target cell, or the having a PCI different from the PCI of the serving cell). The field may indicate the additionalPCIIndex, and/or other logical values corresponding to the cell other than the serving cell.

In some implementations, after the UE receives the DCI including the field used to identify to which TRP the triggered RA procedure corresponds (e.g., the serving cell or the cell having a different from the PCI of the serving cell), the UE may transmit a preamble, based on the instructions provided by the DCI and the RRC-configured PRACH configuration associated with the serving cell or the cell having a PCI different from the PCI of the serving cell, to the one of the two TRPs. After the UE transmits the preamble to the one of the two TRPs, the UE may receive a RAR from the serving cell.

In some implementations, the received RAR may include a field indicating the TAG ID. The TA value indicated in the received RAR may be associated with the TAG ID indicated in the received RAR. The UE may be configured with two TAG IDs associated with the serving cell and the cell having a PCI different from the PCI of the serving cell, respectively, by the serving cell/gNB/NW via RRC signaling. The TAG ID indicated in the received RAR may be associated with one of the two TAG IDs associated with the serving cell and the cell having a PCI different from the PCI of the serving cell.

In some implementations, if the DCI includes the field used to identify the triggered RA procedure corresponding to which TRP (e.g., the serving cell or the cell having a PCI different from the PCI of the serving cell), the UE may not expect the RAR including the field indicating the TAG ID. The association between the TAG ID and the additionalPCIIndex may be configured to the UE via RRC signaling.

In some implementations, if a UE is configured to perform the mTRP-based UL transmission, the UE may receive the DCI (e.g., the DCI format 1_0) triggering the RA procedure corresponding to the TRP that transmits the DCI. For example, if the UE receives the DCI associated with the CORESETPoolIndex=0, the UE may trigger/preform the RA procedure corresponding to the TRP associated with the CORESETPoolIndex=0. If the UE receives the DCI associated with the CORESETPoolIndex=1, the UE may trigger the RA procedure corresponding to the TRP associated with the CORESETPoolIndex=1. Each TRP may be associated with a TRP ID, a CORESETPoolIndex value, an SRS resource set, a PCI value, a serving cell index, and/or an additionalPCIIndex.

In some implementations, a UE may receive, from the serving cell, the DCI that triggers the RA procedure corresponding to one of the two TRPs associated with a serving cell. Each TRP may be associated with an SRS resource set, a CORESETPoolIndex, and/or a TAG ID.

If the DCI triggering the RA procedure is the PDCCH searched by the CORESET with the RRC-configured coresetPoolIndex set to “0,” the UE may transmit the preamble to the TRP associated with the CORESET with the RRC-configured coresetPoolIndex set to “0” based on the PRACH configuration associated with the coresetPoolIndex set to “0” (e.g., the DCI transmitted by the TRP associated with the CORESET with the RRC-configured coresetPoolIndex set to “0”). After the UE transmits the preamble to the TRP associated with the CORESET with the RRC-configured coresetPoolIndex set to “0,” the UE may receive a RAR from the TRP associated with the CORESET with the RRC-configured coresetPoolIndex set to “0.”

In some implementations, the received RAR may include a field indicating the TAG ID. The TA value indicated in the received RAR may be associated with the TAG ID indicated in the received RAR. The UE may be configured by the serving cell/gNB/NW via RRC signaling with two TAG IDs associated with a serving cell. The TAG ID indicated in the received RAR may be associated with one of the two TAG IDs associated with a serving cell. The TAG ID indicated in the RAR may be associated with the TRP associated with the CORESET with the RRC-configured coresetPoolIndex set to “0.”

If the DCI triggering the RA procedure is the PDCCH searched by the CORESET with the RRC-configured coresetPoolIndex set to “1,” the UE may transmit the preamble to the TRP associated with the CORESET with the RRC-configured coresetPoolIndex set to “1” (e.g., the DCI transmitted by the TRP associated with the CORESET with the RRC-configured coresetPoolIndex set to “1”). After the UE transmits the preamble to the TRP associated with the CORESET with the RRC-configured coresetPoolIndex set to “1,” the UE may receive a RAR from the TRP associated with the CORESET with the RRC-configured coresetPoolIndex set to “1.” In some implementations, the received RAR may include a field indicating the TAG ID. The TA value indicated in the received RAR may be associated with the TAG ID indicated in the received RAR. The UE may be configured by the serving cell/gNB/NW via RRC signaling with two TAG IDs associated with a serving cell. The TAG ID indicated in the received RAR may be associated with one of the two TAG IDs associated with a serving cell. The TAG ID indicated in the RAR may be associated with the TRP associated with the CORESET with the RRC-configured coresetPoolIndex set to “1.”

In some implementations, if a UE attempts to detect the DCI format 1_0 with CRC scrambled by the corresponding RA-RNTI in response to a PRACH transmission initiated by a PDCCH order that triggers a contention-free random access procedure for the SpCell associated with two TAGs, the UE may determine that the PDCCH including the DCI format 1_0 has the same DM-RS antenna port quasi co-location properties with at least one of the following (a)-(d):
(a) the SSB indicated in the PDCCH order (e.g., based on the SS/PBCH index field included in the PDCCH order).
(b) the TCI state associated with the TRP used to transmit the PDCCH order (e.g., if a UE is indicated to detect the DCI format 1_0 with CRC scrambled by the corresponding RA-RNTI and receive the RAR from the same TRP used to transmit the PDCCH order).
(c) the TCI state associated with the TRP different from the TRP used to transmit the PDCCH order (e.g., if a UE is indicated to detect the DCI format 1_0 with CRC scrambled by the corresponding RA-RNTI and receive the RAR from the TRP different from the TRP used to transmit the PDCCH order).
(d) the SSB associated with the additionalPCIIndex indicated in the PDDCH order.

In some implementations, if the CRC of the DCI (e.g., the DCI format 1_0) is scrambled by the C-RNTI and the “Frequency domain resource assignment” field includes all ones, the DCI (e.g., the DCI format 1_0) may be for a random access procedure initiated by a PDCCH order, with the other remaining fields set as follows:
(i) the TRP identifier,
(ii) the Random Access Preamble index,
(iii) the UL/SUL indicator,
(iv) the SS/PBCH index,
(v) the PRACH Mask index, and
(vi) the Reserved bits.

In some implementations, the TRP identifier field may be the field indicating the additionalPCIIndex or other logical values corresponding to the cell other than the serving cell. In some implementations, if the value indicated by the TRP identifier field is set to a particular number (e.g., “0”), the UE may detect the DCI format 1_0 with CRC scrambled by the corresponding RA-RNTI and receive the RAR from the serving cell. If the value indicated by the TRP identifier field is set to a particular number (e.g., “N”), the UE may detect the DCI format 1_0 with CRC scrambled by the corresponding RA-RNTI and receive the RAR from the cell associated with the additionalPCIIndex value “N,” N being a positive integer. The serving cell and other cells may be scheduled to a UE for performing the mTRP-based UL transmission.

In some implementations, the TRP identifier field may be the field indicating the CORESETPoolIndex value. The CORESETPoolIndex value may be used to indicate which CORESET (e.g., the CORESET associated with the coresetPoolIndex value “0” or “1”) is used to receive the RAR (e.g., or detect the DCI format 1_0 with CRC scrambled by the corresponding RA-RNTI). For example, if a UE receives the PDCCH order from the first TRP (e.g., associated with the coresetPoolIndex “0”) and the TRP identifier field included in the PDCCH order indicates the coresetPoolIndex “1,” the UE may detect the DCI format 1_0 with CRC scrambled by the corresponding RA-RNTI and receive the RAR from the second TRP (e.g., associated with the coresetPoolIndex “1”). As another example, if a UE receives the PDCCH order from the first TRP (e.g., associated with the coresetPoolIndex “0”) and the TRP identifier field included in the PDCCH order indicates the coresetPoolIndex “0,” the UE may detect the DCI format 1_0 with CRC scrambled by the corresponding RA-RNTI and receive the RAR from the first TRP (e.g., associated with coresetPoolIndex “0”).

In some implementations, the TRP identifier field may be a 1-bit field to indicate to a UE whether to detect the DCI format 1_0 with CRC scrambled by the corresponding RA-RNTI and receive the RAR from the same TRP used to transmit the PDCCH order. For example, if the value indicated by the TRP identifier field is set to a particular number (e.g., “0”), the UE may detect the DCI format 1_0 with CRC scrambled by the corresponding RA-RNTI and receive the RAR from the same TRP used to transmit the PDCCH order. If the value indicated by the TRP identifier field is set to another particular number (e.g., “1”), the UE may detect the DCI format 1_0 with CRC scrambled by the corresponding RA-RNTI and receive the RAR from the TRP (e.g., associated with the first CORESETPoolIndex) different from the TRP (e.g., associated with the second CORESETPoolIndex) used to transmit the PDCCH order. The first CORESETPoolIndex may be different from the second CORESETPoolIndex.

In some implementations, a UE may receive, from the serving cell/gNB/NW, an RRC message configuring two TAG IDs associated with a serving cell. In other words, the RRC-configured serving cell configuration (e.g., the ServingCellConfig) may include two TAG IDs.

In some implementations, the one or two TAG(s), including the SpCell of a MAC entity, may be referred to as the PTAG(s). In other words, the one or two TAG ID(s) included in the RRC-configured serving cell configuration (e.g., the ServingCellConfig) may include the PTAG(s).

In some implementations, two RRC parameters (e.g., the first PTAG (or the primary PTAG) and the second PTAG (or the secondary PTAG)) may be included in a TAG configuration (e.g., the TAG configuration for two TA cases) in the RRC-configured serving cell configuration (e.g., the ServingCellConfig). The TAG configuration may include a list of (to be added, modified, or released) TAG IDs belonging to the PTAGs (e.g., the first PTAG (or primary PTAG), the second PTAG (or secondary PTAG)), a list of (to be added, modified, or released) TAG IDs belonging to the first PTAG (or the primary PTAG), and/or a list of (to be added, modified, or released) TAG IDs belonging to the second PTAG (or the secondary PTAG). The maximum number of the TAG IDs in the list(s) may be four or eight.

In some implementations, two RRC parameters (e.g., the first PTAG (or the primary PTAG) and the second PTAG (or the secondary PTAG)) may be included in a TAG configuration (e.g., the TAG configuration for two TA cases) in the RRC-configured serving cell configuration (e.g., the ServingCellConfig). The TAG configuration may include a list of (to be added, modified, or released) TAG related IEs. The maximum number of the TAG related IEs in the list may be four or eight. Each TAG related IE may include the TAG ID, corresponding time alignment timer, and/or a corresponding indicator. The corresponding indicator may be in ENUMERATED format {′PTAG′}. If the corresponding indicator is ‘PTAG’, it may indicate that the corresponding TAG ID is the PTAG. If the corresponding indicator is absent, it may indicate that the corresponding TAG ID is the STAG, is not the PTAG, or is the primary STAG.

In some implementations, two RRC parameters (e.g., the first PTAG (or the primary PTAG) and the second PTAG (or the secondary PTAG)) may be included in the RRC-configured serving cell configuration (e.g., the ServingCellConfig). For example, the first PTAG (or the primary PTAG) may be associated with the first TAG ID and the second PTAG (or the secondary PTAG) may be associated with the second TAG ID. The first TAG ID may be different from the second TAG ID.

In some implementations, two RRC parameters (e.g., the first TAG ID and the second TAG ID) may be included in the RRC-configured serving cell configuration (e.g., the ServingCellConfig). The first PTAG (or the primary PTAG) may be the TAG with the lowest ID among the two TAG IDs included in the RRC-configured serving cell configuration (e.g., the ServingCellConfig). The second PTAG (or the secondary PTAG) may be another TAG ID different from the TAG ID associated with the first PTAG (or the primary PTAG).

In some implementations, two RRC parameters (e.g., the first TAG ID and the second TAG ID) may be included in the RRC-configured serving cell configuration (e.g., the ServingCellConfig).

In some implementations, the first PTAG (or the primary PTAG) may be the TAG ID associated with the CORESETPoolIndex set to “0.” The second PTAG (or the secondary PTAG) may be the TAG ID associated with the CORESETPoolIndex set to “1.”

In some implementations, the RRC-configured TCI state configuration may include an RRC parameter (e.g., the TAG ID). If the TCI state is used to receive the DCI associated with the CORESETPoolIndex set to “0,” the TAG ID associated with that TCI state may be associated with the first PTAG (or the primary PTAG). If the TCI state is used to receive the DCI associated with the CORESETPoolIndex set to “1,” the TAG ID associated with that TCI state may be associated with the second PTAG (or the secondary PTAG).

In some implementations, the first PTAG (or the primary PTAG) may be associated with the TAG ID associated with the CORESETPoolIndex set to “1.” The second PTAG (or the secondary PTAG) may be associated with the TAG ID associated with the CORESETPoolIndex set to “0.”

In some implementations, the RRC-configured TCI state configuration may include an RRC parameter (e.g., the TAG ID). If the TCI state is used to receive the DCI associated with the CORESETPoolIndex set to “1,” the TAG ID associated with that TCI state may be associated with the first PTAG (or the primary PTAG). If the TCI state is used to receive the DCI associated with the CORESETPoolIndex set to “0,” the TAG ID associated with that TCI state may be associated with the second PTAG (or the secondary PTAG).

In some implementations, the first PTAG (or the primary PTAG) may be associated with the TAG ID associated with the TRP that transmits the RAR and/or the TAC. The second PTAG (or the secondary PTAG) may be associated with another TAG ID different from the TAG ID associated with the first PTAG (or the primary PTAG).

In some implementations, the RRC-configured TCI state configuration may include an RRC parameter (e.g., the TAG ID). The TAG ID corresponding to the TCI state related to the SSB, which is associated with the QCL assumption used for receiving the RAR, may be associated with the first PTAG (or the primary PTAG). Another TAG ID may be associated with the second PTAG (or the secondary PTAG).

In some implementations, one of the two TAGs including the SpCell of a MAC entity may be referred to as the PTAG. The other one of the two TAGs including the SpCell of a MAC entity may be referred to as the STAG (or the primary STAG). In other words, one of the two TAG IDs included in the RRC-configured serving cell configuration (e.g., the ServingCellConfig) may be referred to as the PTAG. The other one of the two TAG IDs included in the RRC-configured serving cell configuration (e.g., the ServingCellConfig) may be referred to as the STAG (or the primary STAG).

In some implementations, two RRC parameters (e.g., the PTAG and the STAG (or the primary STAG)) may be included in a TAG configuration (e.g., the TAG configuration for two TA cases) in the RRC-configured serving cell configuration (e.g., the ServingCellConfig). The TAG configuration may include a list of (to be added, modified, or released) TAG IDs belonging to the PTAGs (e.g., the PTAG), a list of (to be added, modified, or released) TAG IDs belonging to the first STAG (or the primary STAG), and/or a list of (to be added, modified, or released) TAG IDs belonging to the second STAG (or the normal STAG). The maximum number of the TAG IDs in the list(s) may be four or eight.

In some implementations, two RRC parameters (e.g., the PTAG and the STAG (or the primary STAG)) may be included in a TAG configuration (e.g., the TAG configuration for two TA cases) in the RRC-configured serving cell configuration (e.g., the ServingCellConfig). The TAG configuration may include a list of (to be added, modified, or released) TAG related IEs. The maximum number of the TAG related IEs in the list may be four or eight. Each TAG related IE may include the TAG ID, a corresponding time alignment timer, and/or a corresponding indicator. The corresponding indicator may be in an ENUMERATED format {′PTAG′}, ENUMERATED format {‘PTAG’, ‘pSTAG’}, ENUMERATED format {‘PTAG’, ‘pSTAG’, ‘STAG’}, and/or ENUMERATED format {‘PTAG’, ‘pSTAG’, ‘STAG’, ‘reserved’}.

For example, in a case of the ENUMERATED format {′PTAG′}, if the corresponding indicator is ‘PTAG’, it may indicate that the corresponding TAG ID is the PTAG, and if the corresponding indicator is absent, it may indicate that the corresponding TAG ID is the pSTAG (e.g., the primary STAG), is not the PTAG, or is the normal STAG.

For example, in a case of the ENUMERATED format {‘PTAG’, ‘pSTAG’}, if the corresponding indicator is ‘PTAG’, it may indicate that the corresponding TAG ID is the PTAG, if the corresponding indicator is ‘pSTAG’, it may indicate that the corresponding TAG ID is the pSTAG (e.g., the primary STAG), and if the corresponding indicator is absent, it may indicate that the corresponding TAG ID is not the pSTAG (e.g., the primary STAG), is not the PTAG, or is the normal STAG.

For example, in a case of the ENUMERATED format {‘PTAG’, ‘pSTAG’, ‘STAG’}, if the corresponding indicator is ‘PTAG’, it may indicate that the corresponding TAG ID is the PTAG, if the corresponding indicator is ‘pSTAG’, it may indicate that the corresponding TAG ID is the pSTAG (e.g., the primary STAG), if the corresponding indicator is ‘STAG’, it may indicate that the corresponding TAG ID is the STAG (e.g., the normal STAG), and if the corresponding indicator is absent, it may indicate that the corresponding TAG ID is not the pSTAG (e.g., the primary STAG), is not the PTAG, or is not the normal STAG.

In some implementations, two RRC parameters (e.g., the PTAG and the STAG (or the primary STAG)) may be included in the RRC-configured serving cell configuration (e.g., the ServingCellConfig). For example, the PTAG may be associated with the first TAG ID and the STAG (or the primary STAG) may be associated with the second TAG ID. The first TAG ID may be different from the second TAG ID.

In some implementations, two RRC parameters (e.g., the PTAG and the STAG (or the primary STAG)) may be included in the RRC-configured serving cell configuration (e.g., the ServingCellConfig). The PTAG may be TAG with the lowest ID among the two TAG IDs included in the RRC-configured serving cell configuration (e.g., the ServingCellConfig). The STAG (or the primary STAG) may be another TAG ID different from the TAG ID associated with the PTAG.

In some implementations, two RRC parameters (e.g., the first TAG ID and the second TAG ID) may be included in the RRC-configured serving cell configuration (e.g., the ServingCellConfig). In some implementations, the PTAG may be the TAG ID associated with the CORESETPoolIndex set to “0.” The STAG (or the primary STAG) may be the TAG ID associated with the CORESETPoolIndex set to “1.” In some implementations, the RRC-configured TCI state configuration may include an RRC parameter (e.g., the TAG ID). If the TCI state is used to receive the DCI associated with CORESETPoolIndex set to “0,” the TAG ID associated with that TCI state may be associated with the PTAG. If the TCI state is used to receive the DCI associated with CORESETPoolIndex set to “1,” the TAG ID associated with that TCI state may be associated with the STAG (or the primary STAG).

In some implementations, the PTAG may be associated with the TAG ID that is associated with the CORESETPoolIndex set to “1.” The STAG (or the primary STAG) may be associated with the TAG ID that is associated with the CORESETPoolIndex set to “0.” In some implementations, the RRC-configured TCI state configuration may include an RRC parameter (e.g., the TAG ID). If the TCI state is used to receive the DCI associated with CORESETPoolIndex set to “1,” the TAG ID associated with that TCI state may be associated with the PTAG. If the TCI state is used to receive the DCI associated with CORESETPoolIndex set to “0,” the TAG ID associated with that TCI state may be associated with the STAG (or the primary STAG).

In some implementations, the PTAG may be associated with the TAG ID associated with the TRP that transmits the RAR and/or the TAC. The STAG (or the primary STAG) may be associated with another TAG ID different from the TAG ID associated with the PTAG. In some implementations, the RRC-configured TCI state configuration may include an RRC parameter (e.g., the TAG ID). The TAG ID corresponding to the TCI state related to the SSB, which is associated with the QCL assumption used for receiving the RAR, may be associated with the PTAG. Another TAG ID may be associated with the STAG (or the primary STAG).

In some implementations, a UE may receive, from the serving cell/gNB/NW, an RRC message including the RRC-configured TAG configuration that includes the time alignment timer (TAT) (e.g., the timeAlignmentTimer). Each TAG may be associated with a TAT.

In some implementations, the TAT associated with the first PTAG (or the primary PTAG) may be referred to as the first TAT and the TAT associated with the second PTAG (or the secondary PTAG) may be referred to as the second TAT. In some implementations, the TAT associated with the PTAG may be referred to as the first TAT, and the TAT associated with the STAG (or the primary STAG) included in the serving cell containing the PTAG may be referred to as the second TAT.

In some implementations, when the first TAT expires, one or more of the following UE behaviors (a)-(g) may be performed for the TRP belonging to the TAG associated with the first TAT.
(a) flush all the HARQ buffers.
(b) flush the HARQ buffers of the HARQ processes associated with the first TAT, the first TAG/PTAG, or the first TRP (e.g., associated with the first SRS resource set).

In some implementations, a HARQ process may be a HARQ process associated with the first TAT, the first TAG/PTAG, or the first TRP if the one or more of the following conditions (i)-(iv) are satisfied:
(i) The data for the TB of the HARQ process has not been successfully decoded before.
(ii) The corresponding DL assignment (e.g., the DCI and/or the SPS configuration) corresponds to the first CORESET pool index value or the first SRS resource set.
(iii) The corresponding UL grant (e.g., the DCI and/or the CG configuration) corresponds to the first CORESET pool index value or the first SRS resource set.
(iv) The data for the TB of the HARQ process was transmitted to/received from a serving cell associated with the first PTAG (or the primary PTAG)/the first TAT.
(c) notify the RRC layer to release the PUCCH, if configured.
(d) notify the RRC layer to release the SRS, if configured.
(e) clear any configured downlink assignments and configured uplink grants.
(f) clear any PUSCH resource for the semi-persistent CSI reporting.
(g) maintain a TA related parameter (e.g., N_TA) of the TAG associated with the second TAT or first TAT.

In other words, when the first TAT expires, as illustrated in FIG. 1, the UL synchronization status between the UE 102 and the first TRP 104 (e.g., associated with the first SRS resource set and/or the first CORESETPoolIndex) may be “non-synchronized.” The UL synchronization status between the UE 102 and the second TRP 106 (e.g., associated with the second SRS resource set and/or the second CORESETPoolIndex) may be maintained as “synchronized” if the second TAT is still running. The first TRP may be associated with a serving cell belonging to the TAG associated with the first TAT. The second TRP may be associated with the serving cell belonging to the TAG associated with the second TAT.

In some implementations, when the second TAT expires, one or more of the following UE behaviors (a)-(g) may be performed for the TRP belonging to the TAG associated with the second TAT:
(a) flush all the HARQ buffers.
(b) flush the HARQ buffers associated with the second TAT, the second TAG/PTAG, or the second TRP (e.g., associated with the second SRS resource set).

In some implementations, a HARQ process may be a HARQ process associated with the second TAT, the second TAG/PTAG, or the second TRP if the one or more of the following conditions (i)-(iv) are satisfied:
(i) The data for the TB of the HARQ process has not been successfully decoded before.
(ii) The corresponding DL assignment (e.g., the DCI and/or the SPS configuration) corresponds to the second CORESET pool index value or the second SRS resource set.
(iii) The corresponding UL grant (e.g., the DCI and/or the CG configuration) corresponds to the second CORESET pool index value or the second SRS resource set.
(iv) The data for the TB of the HARQ process was transmitted to/received from a serving cell associated with the second PTAG (or the secondary PTAG)/the second TAT.
(c) notify the RRC layer to release the PUCCH, if configured.
(d) notify the RRC layer to release the SRS, if configured.
(e) clear any configured downlink assignments and configured uplink grants.
(f) clear any PUSCH resource for the semi-persistent CSI reporting.
(g) maintain a TA related parameter (e.g., N_TA) of the TAG associated with the second TAT.

In other words, when the second TAT expires, as illustrated in FIG. 1, the UL synchronization status between the UE 102 and the second TRP 106 (e.g., associated with the second SRS resource set and/or the second CORESETPoolIndex) may be “non-synchronized.” The UL synchronization status between the UE 102 and the first TRP 104 (e.g., associated with the first SRS resource set and/or the first CORESETPoolIndex) may be maintained as “synchronized” if the first TAT is still running. The first TRP may be associated with a serving cell belonging to the TAG associated with the first TAT. The second TRP may be associated with the serving cell belonging to the TAG associated with the second TAT.

In some implementations, when the first TAT expires, one or more of the following UE behaviors (a)-(g) may be performed for all the serving cells belonging to the TAG associated with the first TAT.
(a) flush all the HARQ buffers.
(b) flush the HARQ buffers of the HARQ processes associated with the first TAT, the first TAG/PTAG, or the first TRP (e.g., associated with the second SRS resource set).

In some implementations, a HARQ process may be a HARQ process associated with the first TAT or the first TAG/PTAG, or the first TRP if the one or more of the following conditions (i)-(iv) are satisfied:
(i) The data for the TB of the HARQ process has not been successfully decoded before.
(ii) The corresponding DL assignment (e.g., the DCI and/or the SPS configuration) corresponds to the first CORESET pool index value or the first SRS resource set.
(iii) The corresponding UL grant (e.g., the DCI and/or the CG configuration) corresponds to the first CORESET pool index value or the first SRS resource set.
(iv) The data for the TB of the HARQ process was transmitted to/received from a serving cell associated with the first PTAG (or the primary PTAG)/the first TAT.
(c) notify the RRC layer to release the PUCCH, if configured.
(d) notify the RRC layer to release the SRS, if configured.
(e) clear any configured downlink assignments and configured uplink grants.
(f) clear any PUSCH resource for the semi-persistent CSI reporting.
(g) maintain a TA related parameter (e.g., N_TA) of the TAG associated with the first TAT.

In some implementations, when the second TAT expires, one or more of the following UE behaviors (a)-(g) may be performed for all the serving cells belonging to the TAG associated with the second TAT.
(a) flush all the HARQ buffers.
(b) flush the HARQ buffers associated with the second TAT, the second TAG/PTAG, or the second TRP.

In some implementations, a HARQ process may be a HARQ process associated with the second TAT, the second TAG/PTAG, or the second TRP if the one or more of following conditions (i)-(iv) are satisfied:
(i) The data for the TB of the HARQ process has not been successfully decoded before.
(ii) The corresponding DL assignment (e.g., the DCI and/or the SPS configuration) corresponds to the second CORESETPoolIndex value or the second SRS resource set.
(iii) The corresponding UL grant (e.g., the DCI and/or the CG configuration) corresponds to the second CORESET pool index value or the second SRS resource set.
(iv) The data for the TB of the HARQ process was transmitted to/received from a serving cell associated with the second PTAG (or the secondary PTAG)/the second TAT.
(c) notify the RRC layer to release the PUCCH, if configured.
(d) notify the RRC layer to release the SRS, if configured.
(e) clear any configured downlink assignments and configured uplink grants.
(f) clear any PUSCH resource for the semi-persistent CSI reporting.
(g) maintain a TA related parameter (e.g., N_TA) of the TAG associated with the second TAT.

In some implementations, when one of the first TAT and the second TAT expires, one or more of the following UE behaviors (a)-(g) may be performed for all the serving cells.
(a) flush all the HARQ buffers.
(b) notify the RRC layer to release the PUCCH, if configured.
(c) notify the RRC layer to release the SRS, if configured.
(d) clear any configured downlink assignments and configured uplink grants.
(e) clear any PUSCH resource for the semi-persistent CSI reporting.
(f) determine all running timeAlignmentTimers as expired.
(g) maintain a TA related parameter (e.g., N_TA) of all TAGs.

In some implementations, when both the first TAT and the second TAT expire, one or more of the following UE behaviors (a)-(g) may be performed for all the serving cells.
(a) flush all the HARQ buffers.
(b) notify the RRC layer to release the PUCCH, if configured.
(c) notify the RRC layer to release the SRS, if configured.
(d) clear any configured downlink assignments and configured uplink grants.
(e) clear any PUSCH resource for the semi-persistent CSI reporting.
(f) determine all running timeAlignmentTimers as expired.
(g) maintain a TA related parameter (e.g., N_TA) of all TAGs.

In some implementations, if there are two TATs and one of them expires, the UE may not flush all the HARQ buffers and release the UL resources even though the other TAT expires, under the following conditions (a) and (b):
(a) The UE has already transmitted a preamble and is waiting for the corresponding RAR and the TA value related to a specific TRP (e.g., a CORESETPoolIndex set) associated with the TAT that expires first.
(b) A new timer is running. The new timer is configured under the mTRP UL 2TA application. In some implementations, the UE may start the new timer when both of the two TATs expire, and the UE may stop the new timer upon receiving the TAC or the RAR. In some implementations, the UE may start the new timer when one of the two TATs expires, and the UE may stop the new timer upon receiving the TAC or the RAR.

In some implementations, if a UE is provided with an RRC parameter ackNackFeedbackMode=joint and the UL synchronization status corresponding to the TRP that the UE is configured to transmit the HARQ information is “non-synchronized” (e.g., the TAT corresponding to the TRP that the UE is configured to transmit the HARQ information expires), the UE may flush all the HARQ buffers for all the serving cells.

In some implementations, if a UE is provided with an RRC parameter ackNackFeedbackMode=joint and the UL synchronization status corresponding to the TRP (e.g., first TRP associated with the first CORESETPoolIndex value) that the UE is configured to transmit the HARQ information is “synchronized” (e.g., the TAT (e.g., the first TAT) corresponding to the TRP that the UE is configured to transmit the HARQ information expires) and the UL synchronization status corresponding to another TRP (e.g., the second TRP associated with the first CORESETPoolIndex value) is “non-synchronized” (e.g., the TAT (e.g., the second TAT) corresponding to another TRP (e.g., the second TRP associated with the second CORESETPoolIndex value) expires), the UE may not flush the HARQ buffers corresponding to another TRP (e.g., the second TRP associated with the second CORESETPoolIndex value). The first CORESETPookIndex may be different from the second CORESETPoolIndex. The TAG associated with the first TAT and the TAG associated with the second TAT may be associated with the same serving cell.

In some implementations, if a timeAlignmentTimer expires and the timeAlignmentTimer is associated with one of the two TAGs including the SpCell (of a MAC entity), the UE may perform one or more of the following actions (a)-(g):
(a) flush all the HARQ buffers for all the serving cells.
(b) notify the RRC layer to release the PUCCH for all the serving cells, if configured.
(c) notify the RRC layer to release the SRS for all the serving cells, if configured.
(d) clear any configured downlink assignments and configured uplink grants.
(e) clear any PUSCH resource for the semi-persistent CSI reporting.
(f) determine all running timeAlignmentTimers as expired.
(g) maintain a TA related parameter (e.g., N_TA) of all TAGs.

If the timeAlignmentTimer is not associated with any one of the two TAGs including the SpCell (of a MAC entity) or if the timeAlignmentTimer is associated with a normal STAG, the UE may perform one or more of the following actions (a)-(f) for all the serving cells belonging to the STAG:
(a) flush all the HARQ buffers.
(b) notify the RRC layer to release the PUCCH, if configured.
(c) notify the RRC layer to release the SRS, if configured.
(d) clear any configured downlink assignments and configured uplink grants.
(e) clear any PUSCH resource for the semi-persistent CSI reporting.
(f) maintain a TA related parameter (e.g., N_TA) of the STAG.

In some implementations, if a timeAlignmentTimer expires and the timeAlignmentTimer is associated with a first PTAG (or a primary PTAG), the UE may perform one or more of the following actions (a)-(g):
(a) flush all the HARQ buffers for all the serving cells.
(b) notify the RRC layer to release the PUCCH for all the serving cells, if configured.
(c) notify the RRC layer to release the SRS for all the serving cells, if configured.
(d) clear any configured downlink assignments and configured uplink grants.
(e) clear any PUSCH resource for the semi-persistent CSI reporting.
(f) determine all running timeAlignmentTimers as expired.
(g) maintain a TA related parameter (e.g., N_TA) of all TAGs.

In some implementations, if the timeAlignmentTimer is associated with a second PTAG (or a secondary PTAG), the UE may perform one or more of the following actions (a)-(g):
(a) flush all the HARQ buffers for all the serving cells.
(b) notify the RRC layer to release the PUCCH for all the serving cells, if configured.
(c) notify the RRC layer to release the SRS for all the serving cells, if configured.
(d) clear any configured downlink assignments and configured uplink grants.
(e) clear any PUSCH resource for the semi-persistent CSI reporting.
(f) determine all running timeAlignmentTimers as expired.
(g) maintain a TA related parameter (e.g., N_TA) of all TAGs.

In some implementations, if the timeAlignmentTimer is associated with a second PTAG (or a secondary PTAG), the UE may perform one or more of the following actions (a)-(m):
(a) flush all the HARQ buffers corresponding to the TRP associated with the second PTAG (or the secondary PTAG).
(b) notify the RRC layer to release the PUCCH corresponding to the TRP associated with the second PTAG (or the secondary PTAG), if configured.
(c) notify the RRC layer to release the SRS corresponding to the TRP associated with the second PTAG (or the secondary PTAG), if configured. The released SRS(es) may be associated with the SRS resource set associated with the TRP associated with the second PTAG (or the secondary PTAG).
(d) clear any configured downlink assignments and configured uplink grants corresponding to the TRP associated with the second PTAG (or the secondary PTAG).
(e) clear any PUSCH resource for the semi-persistent CSI reporting corresponding to the TRP associated with the second PTAG (or the secondary PTAG).
(f) maintain a TA related parameter (e.g., N_TA) of the second PTAG (or the secondary PTAG).
(g) flush all the HARQ buffers for all the serving cells.
(h) notify the RRC layer to release the PUCCH for all the serving cells, if configured.
(i) notify the RRC layer to release the SRS for all the serving cells, if configured.
(j) clear any configured downlink assignments and configured uplink grants.
(k) clear any PUSCH resource for the semi-persistent CSI reporting.
(l) determine all running timeAlignmentTimers as expired.
(m) maintain a TA related parameter (e.g., N_TA) of all TAGs.

In some implementations, if the timeAlignmentTimer is associated with a first PTAG (or a primary PTAG), the UE may perform one or more of the following actions (a)-(m):
(a) flush all the HARQ buffers corresponding to the TRP associated with the first PTAG (or the primary PTAG).
(b) notify the RRC layer to release the PUCCH corresponding to the TRP associated with the first PTAG (or the primary PTAG), if configured.
(c) notify the RRC layer to release the SRS corresponding to the TRP associated with the first PTAG (or the primary PTAG), if configured. The released SRS(es) may be associated with the SRS resource set associated with the TRP associated with the first PTAG (or the primary PTAG).
(d) clear any configured downlink assignments and configured uplink grants corresponding to the TRP associated with the first PTAG (or the primary PTAG).
(e) clear any PUSCH resource for the semi-persistent CSI reporting corresponding to the TRP associated with the first PTAG (or the primary PTAG).
(f) maintain a TA related parameter (e.g., N_TA) of the first PTAG (or the primary PTAG).
(g) flush all the HARQ buffers for all the serving cells.
(h) notify the RRC layer to release the PUCCH for all the serving cells, if configured.
(i) notify the RRC layer to release the SRS for all the serving cells, if configured.
(j) clear any configured downlink assignments and configured uplink grants.
(k) clear any PUSCH resource for the semi-persistent CSI reporting.
(l) determine all running timeAlignmentTimers as expired.
(m) maintain a TA related parameter (e.g., N_TA) of all TAGs.

In some implementations, if the timeAlignmentTimer is associated with a primary STAG, the UE may perform one or more of the following actions (a)-(m):
(a) flush all the HARQ buffers corresponding to the TRP associated with the primary STAG.
(b) notify the RRC layer to release the PUCCH corresponding to the TRP associated with the primary STAG, if configured.
(c) notify the RRC layer to release the SRS corresponding to the TRP associated with the primary STAG, if configured. The released SRS(es) may be associated with the SRS resource set associated with the he TRP associated with the primary STAG.
(d) clear any configured downlink assignments and configured uplink grants corresponding to the TRP associated with the primary STAG.
(e) clear any PUSCH resource for the semi-persistent CSI reporting corresponding to the TRP associated with the primary STAG.
(f) maintain a TA related parameter (e.g., N_TA) of the primary STAG.
(g) flush all the HARQ buffers for all the serving cells.
(h) notify the RRC layer to release the PUCCH for all the serving cells, if configured.
(i) notify the RRC layer to release the SRS for all the serving cells, if configured.
(j) clear any configured downlink assignments and configured uplink grants.
(k) clear any PUSCH resource for the semi-persistent CSI reporting.
(l) determine all running timeAlignmentTimers as expired.
(m) maintain a TA related parameter (e.g., N_TA) of all TAGs.

In some implementations, if a first PTAG (or primary PTAG) and a second PTAG (or secondary PTAG) are configured to a UE to maintain TAs for the multi-DCI m-TRP-based UL transmission, and if the timeAlignmentTimer associated with the first PTAG (or primary PTAG) expires, the UE may perform one or more of the following actions (a)-(g):
(a) flush all the HARQ buffers for all the serving cells.
(b) notify the RRC layer to release the PUCCH for all the serving cells, if configured.
(c) notify the RRC layer to release the SRS for all the serving cells, if configured.
(d) clear any configured downlink assignments and configured uplink grants.
(e) clear any PUSCH resource for the semi-persistent CSI reporting.
(f) determine all running timeAlignmentTimers as expired.
(g) maintain a TA related parameter (e.g., N_TA) of all TAGs.

In some implementations, if a PTAG and a primary STAG are configured to a UE to maintain TAs for multi-DCI mTRP-based UL transmission, and if the timeAlginmentTimer associated with the PTAG expires, the UE may perform one or more of the following actions (a)-(g):
(a) flush all the HARQ buffers for all the serving cells.
(b) notify the RRC layer to release the PUCCH for all the serving cells, if configured.
(c) notify the RRC layer to release the SRS for all the serving cells, if configured.
(d) clear any configured downlink assignments and configured uplink grants.
(e) clear any PUSCH resource for the semi-persistent CSI reporting.
(f) determine all running timeAlignmentTimers as expired.
(g) maintain a TA related parameter (e.g., N_TA) of all TAGs.

In some implementations, a UE may be configured with two TATs, and each of the two TATs may be associated with a TAG ID, respectively. The two TAG IDs may be associated with a serving cell. In some implementations, one TAG ID may be associated with a serving cell and another TAG ID may be associated with a cell having a PCI different from the PCI of the serving cell. If the TAT associated with the STAG (or the PTAG, the pSTAG) expires, the MAC layer of the UE may inform the upper layer (e.g., the RRC layer of the UE) that the TAT associated with the STAG (or the PTAG, the pSTAG) has expired. After the MAC layer of the UE inform the upper layer of the UE of such information, at least one of the following actions (a) and (b) may be performed:
(a) The upper layer of the UE (e.g., the RRC layer) may indicate to the lower layer of the UE (e.g., the MAC layer) a new TAG ID.
(b) The UE may perform/initiate the RA procedure corresponding to the TRP associated with the expired TAT. The PRACH configuration may be associated with the TRP associated with the expired TAT. The PRACH configuration may include an indication to indicate that the PRACH configuration is associated with which TRP (e.g., the CORESETPoolIndex, the additionalPCIIndex, the TRP ID, the SRS resource set ID).

In some embodiments, a UE may receive, from a serving cell, a first RRC parameter (e.g., including a first TAG ID) and a second RRC parameter (e.g., including a second TAG ID). The first TAG ID and the second TAG ID may be included in an RRC-configured IE (e.g., the ServingCellConfig). The first TAG ID may be associated with a first TAT and the second TAG ID may be associated with a second TAT.

In a case that the first TAT expires, the UE may perform the one or more of the following actions (a)-(f) for the TRP belonging to the TAG associated with the first TAT.
(a) flush all the HARQ buffers.
(b) notify the RRC layer to release the PUCCH, if configured.
(c) notify the RRC layer to release the SRS, if configured.
(d) clear any configured downlink assignments and configured uplink grants.
(e) clear any PUSCH resource for the semi-persistent CSI reporting.
(f) maintain a TA related parameter (e.g., N_TA) of the TAG associated with the first TAT.

In the case that the second TAT expires, the UE may perform one or more of the following actions (a)-(f) for the TRP belonging to the TAG associated with the second TAT.
(a) flush all the HARQ buffers.
(b) notify the RRC layer to release the PUCCH, if configured.
(c) notify the RRC layer to release the SRS, if configured.
(d) clear any configured downlink assignments and configured uplink grants.
(e) clear any PUSCH resource for the semi-persistent CSI reporting.
(f) maintain a TA related parameter (e.g., N_TA) of the TAG associated with the second TAT.

In the case that both the first TAT and the second TAT expire, the UE may perform one or more of the following actions (a)-(g) for all the serving cells.
(a) flush all the HARQ buffers.
(b) notify the RRC layer to release the PUCCH, if configured.
(c) notify the RRC layer to release the SRS, if configured.
(d) clear any configured downlink assignments and configured uplink grants.
(e) clear any PUSCH resource for the semi-persistent CSI reporting.
(f) determine all running timeAlignmentTimers as expired.
(g) maintain a TA related parameter (e.g., N_TA) of all TAGs.

The first TAT and the second TAT may be associated a first PTAG (or a primary PTAG) and a second PTAG (or a secondary PTAG), and the serving cell may belong to the first PTAG (or the primary PTAG) and the second PTAG (or the secondary PTAG). The first TAT and the second TAT may be associated a PTAG and a primary STAG, and the serving cell may belong to the PTAG and the primary STAG. The serving cell may belong to the TAG associated with the first TAG ID and the TAG associated with the second TAG ID. The TAG associated with the first TAG ID may be associated with a first TRP, a first SRS resource set, a first TCI state, and/or a first CORESETPoolIndex. The TAG associated with the second TAG ID may be associated with a second TRP, a second SRS resource set, a second TCI state, and/or a second CORESETPoolIndex.

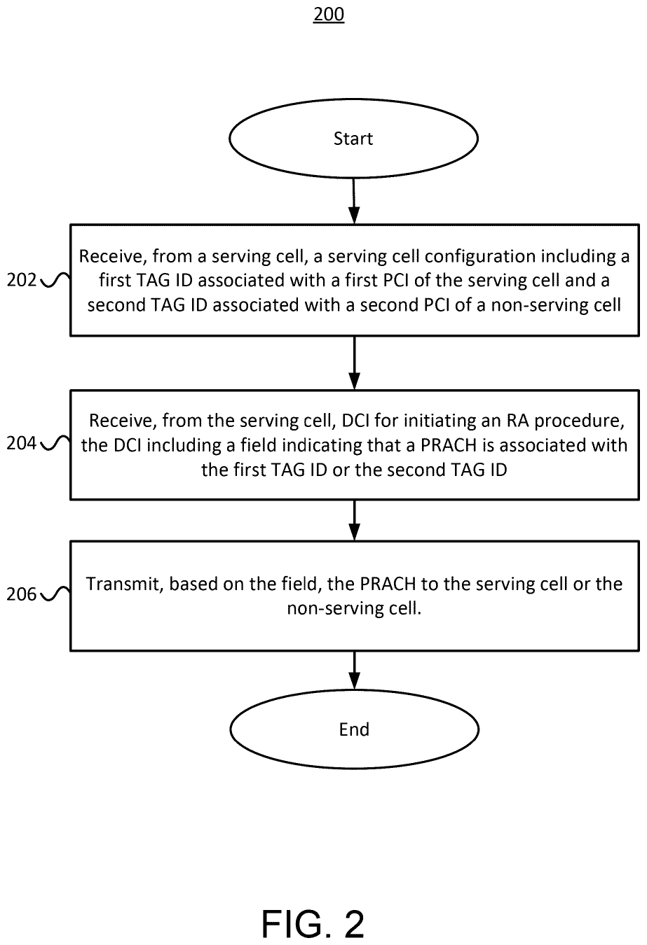

FIG. 2 is a flowchart illustrating a method/process 200 performed by a UE for an mTRP-based operation, according to an example implementation of the present disclosure.

Process 200 may start, in action 202, by the UE receiving, from a serving cell, a serving cell configuration including a first timing advance group (TAG) identity (ID) associated with a first physical cell identity (PCI) of the serving cell and a second TAG ID associated with a second PCI of a non-serving cell.

In action 204, the UE may receive, from the serving cell, downlink control information (DCI) for initiating a random access (RA) procedure, the DCI including a field indicating that a physical random access channel (PRACH) is associated with the first TAG ID or the second TAG ID.

In action 206, the UE may transmit, based on the field, the PRACH to the serving cell or the non-serving cell. In some implementations, in a case that the field indicates that the PRACH is associated with the second TAG ID, the UE may transmit the PRACH based on an RA resource associated with the second TAG ID.

In some implementations, in a case that the field indicates that the PRACH is associated with the first TAG ID, the UE may transmit, based on the field, the PRACH to the serving cell, and receive, from the serving cell, a random access response (RAR). In a case that the field indicates that the PRACH is associated with the second TAG ID, the UE may transmit, based on the field, the PRACH to the non-serving cell. The UE may receive, from the serving cell, the RAR. In some implementations, in a case that the field indicates that the PRACH is associated with the first TAG ID, the RAR may indicate a first timing advance (TA) value associated with the first TAG ID, and in a case that the field indicates that the PRACH is associated with the second TAG ID, the RAR may indicate a second TA value associated with the second TAG ID.

In some implementations, in a case that a timing alignment timer (TAT) associated with the first TAG ID expires, the UE may clear every configured downlink assignment associated with the first TAG ID, without clearing any configured uplink grant associated with the first TAG ID. In some implementations, in a case that a timing alignment timer (TAT) associated with the first TAG ID expires, the UE may clear every configured uplink grant associated with the first TAG ID, without clearing any configured downlink assignment associated with the first TAG ID. In some implementations, in a case that a timing alignment timer (TAT) associated with the first TAG ID expires, the UE may clear every physical uplink shared channel (PUSCH) resource for a semi-persistent channel state information (CSI) reporting associated with the first TAG ID, without maintaining a timing advance (TA) related parameter associated with the first TAG ID. In some implementations, in a case that a timing alignment timer (TAT) associated with the first TAG ID expires, the UE may maintain a timing advance (TA) related parameter associated with the first TAG ID, without clearing any physical uplink shared channel (PUSCH) resource for a semi-persistent channel state information (CSI) reporting associated with the first TAG ID.

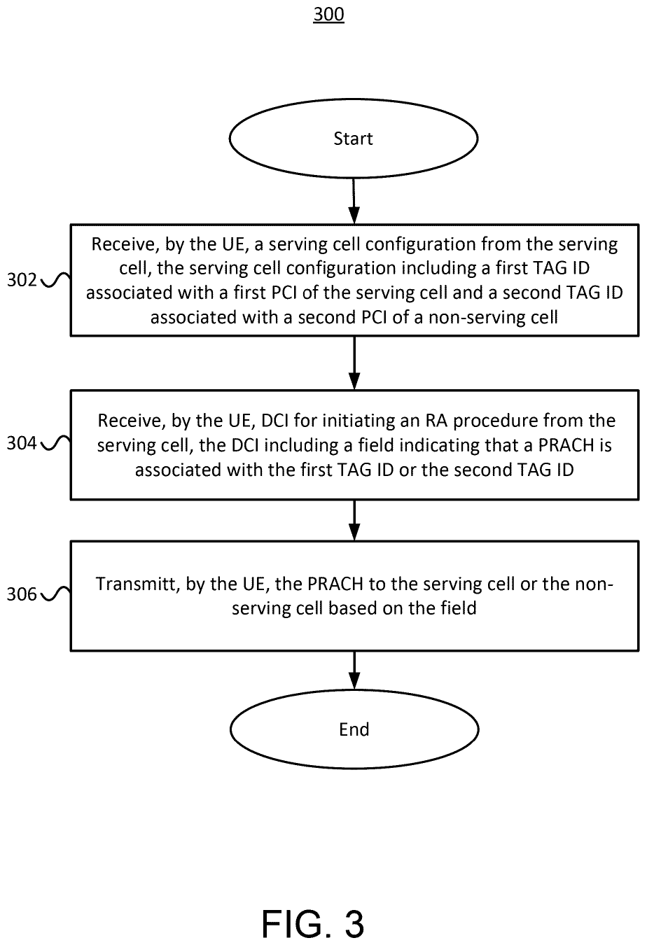

FIG. 3 is a flowchart illustrating a method/process 300 performed by a communication system for an mTRP-based operation, according to an example implementation of the present disclosure. The communication system may include a user equipment (UE), a serving cell, and a non-serving cell.

Process 300 may start, in action 302, by the UE receiving a serving cell configuration from the serving cell, the serving cell configuration including a first timing advance group (TAG) identity (ID) associated with a first physical cell identity (PCI) of the serving cell and a second TAG ID associated with a second PCI of a non-serving cell.

In action 304, the UE may receive downlink control information (DCI) for initiating a random access (RA) procedure from the serving cell, the DCI including a field indicating that a physical random access channel (PRACH) is associated with the first TAG ID or the second TAG ID.

In action 306, the UE may transmit the PRACH to the serving cell or the non-serving cell based on the field.

In some implementations, in a case that the field indicates that the PRACH is associated with the second TAG ID, the UE may transmit the PRACH based on an RA resource associated with the second TAG ID.

In some implementations, in a case that the field indicates that the PRACH is associated with the first TAG ID, the UE may transmit the PRACH to the serving cell based on the field, and receive a random access response (RAR) from the serving cell, and in a case that the field indicates that the PRACH is associated with the second TAG ID, the UE may transmit the PRACH to the non-serving cell based on the field, and receive the RAR from the serving cell.

In some implementations, in a case that the field indicates that the PRACH is associated with the first TAG ID, the RAR may indicate a first timing advance (TA) value associated with the first TAG ID, and in a case that the field indicates that the PRACH is associated with the second TAG ID, the RAR may indicate a second TA value associated with the second TAG ID.

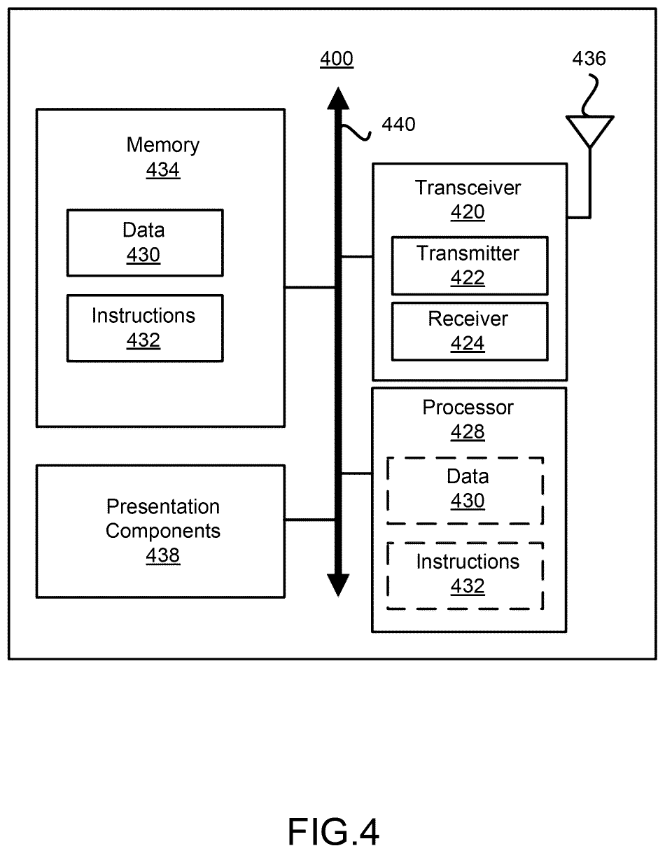

FIG. 4 is a block diagram illustrating a node 400 for wireless communication in accordance with various aspects of the present disclosure. As illustrated in FIG. 4, a node 400 may include a transceiver 420, a processor 428, a memory 434, one or more presentation components 438, and at least one antenna 436. The node 400 may also include a radio frequency (RF) spectrum band module, a BS communications module, a network communications module, and a system communications management module, Input/Output (I/O) ports, I/O components, and a power supply (not illustrated in FIG. 4).

Each of the components may directly or indirectly communicate with each other over one or more buses 440. The node 400 may be a UE or a BS that performs various functions disclosed with reference to FIG. 1 to FIG. 3.

The transceiver 420 has a transmitter 422 (e.g., transmitting/transmission circuitry) and a receiver 424 (e.g., receiving/reception circuitry) and may be configured to transmit and/or receive time and/or frequency resource partitioning information. The transceiver 420 may be configured to transmit in different types of subframes and slots including, but not limited to, usable, non-usable, and flexibly usable subframes and slot formats. The transceiver 420 may be configured to receive data and control channels.

The node 400 may include a variety of computer-readable media. Computer-readable media may be any available media that may be accessed by the node 400 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 434 may include computer-storage media in the form of volatile and/or non-volatile memory. The memory 434 may be removable, non-removable, or a combination thereof. Example memory may include solid-state memory, hard drives, optical-disc drives, etc. As illustrated in FIG. 4, the memory 434 may store a computer-readable and/or computer-executable instructions 432 (e.g., software codes) that are configured to, when executed, cause the processor 428 to perform various functions disclosed herein, for example, with reference to FIG. 1 to FIG. 3. Alternatively, the instructions 432 may not be directly executable by the processor 428 but may be configured to cause the node 400 (e.g., when compiled and executed) to perform various functions disclosed herein.

The processor 428 (e.g., having processing circuitry) may include an intelligent hardware device, e.g., a Central Processing Unit (CPU), a microcontroller, an ASIC, etc. The processor 428 may include memory. The processor 428 may process the data 430 and the instructions 432 received from the memory 434, and information transmitted and received via the transceiver 420, the baseband communications module, and/or the network communications module. The processor 428 may also process information to send to the transceiver 420 for transmission via the antenna 436 to the network communications module for transmission to a CN.

One or more presentation components 438 may present data indications to a person or another device. Examples of presentation components 438 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a user equipment (UE) for a multi-transmission and reception point (mTRP)-based operation, the method comprising:
receiving, from a serving cell, a serving cell configuration comprising a first timing advance group (TAG) identity (ID) associated with a first physical cell identity (PCI) of the serving cell and a second TAG ID associated with a second PCI of a non-serving cell;
receiving, from the serving cell, downlink control information (DCI) for initiating a random access (RA) procedure, the DCI comprising a field indicating that a physical random access channel (PRACH) is associated with the first TAG ID or the second TAG ID; and
transmitting, based on the field, the PRACH to the serving cell or the non-serving cell.

2. The method of claim 1, further comprising:
in a case that the field indicates that the PRACH is associated with the second TAG ID, transmitting the PRACH based on an RA resource associated with the second TAG ID.

3. The method of claim 1, further comprising:
in a case that the field indicates that the PRACH is associated with the first TAG ID:
transmitting, based on the field, the PRACH to the serving cell, and
receiving, from the serving cell, a random access response (RAR); and
in a case that the field indicates that the PRACH is associated with the second TAG ID:
transmitting, based on the field, the PRACH to the non-serving cell, and
receiving, from the serving cell, the RAR.

4. The method of claim 3, wherein:
in a case that the field indicates that the PRACH is associated with the first TAG ID, the RAR indicates a first timing advance (TA) value associated with the first TAG ID, and
in a case that the field indicates that the PRACH is associated with the second TAG ID, the RAR indicates a second TA value associated with the second TAG ID.

5. The method of claim 1, further comprising:
in a case that a timing alignment timer (TAT) associated with the first TAG ID expires, clearing every configured downlink assignment associated with the first TAG ID, without clearing any configured uplink grant associated with the first TAG ID.

6. The method of claim 1, further comprising:
in a case that a timing alignment timer (TAT) associated with the first TAG ID expires, clearing every configured uplink grant associated with the first TAG ID, without clearing any configured downlink assignment associated with the first TAG ID.

7. The method of claim 1, further comprising:
in a case that a timing alignment timer (TAT) associated with the first TAG ID expires, clearing every physical uplink shared channel (PUSCH) resource for a semi-persistent channel state information (CSI) reporting associated with the first TAG ID, without maintaining a timing advance (TA) related parameter associated with the first TAG ID.

8. The method of claim 1, further comprising:
in a case that a timing alignment timer (TAT) associated with the first TAG ID expires, maintaining a timing advance (TA) related parameter associated with the first TAG ID, without clearing any physical uplink shared channel (PUSCH) resource for a semi-persistent channel state information (CSI) reporting associated with the first TAG ID.

9. A user equipment (UE) for a multi-transmission and reception point (mTRP)-based operation, the UE comprising:
at least one processor; and
at least one non-transitory computer-readable medium coupled to the at least one processor and storing one or more computer-executable instructions that, when executed by the at least one processor, cause the UE to:
receive, from a serving cell, a serving cell configuration comprising a first timing advance group (TAG) identity (ID) associated with a first physical cell identity (PCI) of the serving cell and a second TAG ID associated with a second PCI of a non-serving cell;
receive, from the serving cell, downlink control information (DCI) for initiating a random access (RA) procedure, the DCI comprising a field indicating that a physical random access channel (PRACH) is associated with the first TAG ID or the second TAG ID; and
transmit, based on the field, the PRACH to the serving cell or the non-serving cell.

10. The UE of claim 9, wherein the one or more computer-executable instructions, when executed by the at least one processor, further cause the UE to:
in a case that the field indicates that the PRACH is associated with the second TAG ID, transmit the PRACH based on an RA resource associated with the second TAG ID.

11. The UE of claim 9, wherein the one or more computer-executable instructions, when executed by the at least one processor, further cause the UE to:
in a case that the field indicates that the PRACH is associated with the first TAG ID:
transmit, based on the field, the PRACH to the serving cell, and
receive, from the serving cell, a random access response (RAR); and
in a case that the field indicates that the PRACH is associated with the second TAG ID:
transmit, based on the field, the PRACH to the non-serving cell, and
receive, from the serving cell, the RAR.

12. The UE of claim 11, wherein:
in a case that the field indicates that the PRACH is associated with the first TAG ID, the RAR indicates a first timing advance (TA) value associated with the first TAG ID, and
in a case that the field indicates that the PRACH is associated with the second TAG ID, the RAR indicates a second TA value associated with the second TAG ID.

13. The UE of claim 9, wherein the one or more computer-executable instructions, when executed by the at least one processor, further cause the UE to:
in a case that a timing alignment timer (TAT) associated with the first TAG ID expires, clear every configured downlink assignment associated with the first TAG ID, without clearing any configured uplink grant associated with the first TAG ID.

14. The UE of claim 9, wherein the one or more computer-executable instructions, when executed by the at least one processor, further cause the UE to:
in a case that a timing alignment timer (TAT) associated with the first TAG ID expires, clear every configured uplink grant associated with the first TAG ID, without clearing any configured downlink assignment associated with the first TAG ID.

15. The UE of claim 9, wherein the one or more computer-executable instructions, when executed by the at least one processor, further cause the UE to:
in a case that a timing alignment timer (TAT) associated with the first TAG ID expires, clear every physical uplink shared channel (PUSCH) resource for a semi-persistent channel state information (CSI) reporting associated with the first TAG ID, without maintaining a timing advance (TA) related parameter associated with the first TAG ID.

16. The UE of claim 9, wherein the one or more computer-executable instructions, when executed by the at least one processor, further cause the UE to:
in a case that a timing alignment timer (TAT) associated with the first TAG ID expires, maintain a timing advance (TA) related parameter associated with the first TAG ID, without clearing any physical uplink shared channel (PUSCH) resource for a semi-persistent channel state information (CSI) reporting associated with the first TAG ID.

17. A method performed by a communication system for a multi-transmission and reception point (mTRP)-based operation, the communication system comprising a user equipment (UE), a serving cell, and a non-serving cell, the method comprising:
receiving, by the UE, a serving cell configuration from the serving cell, the serving cell configuration comprising a first timing advance group (TAG) identity (ID) associated with a first physical cell identity (PCI) of the serving cell and a second TAG ID associated with a second PCI of a non-serving cell;
receiving, by the UE, downlink control information (DCI) for initiating a random access (RA) procedure from the serving cell, the DCI comprising a field indicating that a physical random access channel (PRACH) is associated with the first TAG ID or the second TAG ID; and
transmitting, by the UE, the PRACH to the serving cell or the non-serving cell based on the field.

18. The method of claim 17, further comprising:
in a case that the field indicates that the PRACH is associated with the second TAG ID, transmitting, by the UE, the PRACH based on an RA resource associated with the second TAG ID.

19. The method of claim 17, further comprising:
in a case that the field indicates that the PRACH is associated with the first TAG ID:
transmitting, by the UE, the PRACH to the serving cell based on the field, and
receiving, by the UE, a random access response (RAR) from the serving cell; and
in a case that the field indicates that the PRACH is associated with the second TAG ID:
transmitting, by the UE, the PRACH to the non-serving cell based on the field, and
receiving, by the UE, the RAR from the serving cell.

20. The method of claim 19, wherein:
in a case that the field indicates that the PRACH is associated with the first TAG ID, the RAR indicates a first timing advance (TA) value associated with the first TAG ID, and
in a case that the field indicates that the PRACH is associated with the second TAG ID, the RAR indicates a second TA value associated with the second TAG ID.
